(19) United States
(12) Patent Application Publication
(10) Pub. No.: US 2019/0155131 A1
(43) Pub. Date: May 23, 2019

(54) MONITORING DEVICE

(71) Applicant: Robert Bosch GmbH, Stuttgart (DE)

(72) Inventors: Hendrik Specht, Pliezhausen (DE); Alexander Ehlert, Reutlingen (DE); Christoph Puttmann, Kusterdingen (DE)

(21) Appl. No.: 16/171,662

(22) Filed: Oct. 26, 2018

(30) Foreign Application Priority Data
Nov. 22, 2017 (DE) 102017220822.8

(51) Int. Cl. G03B 21/00; G02B 26/08; G02B 26/10

(52) U.S. Cl. CPC G03B 21/008; G01D 5/16; G02B 26/105; G02B 26/0833

(57) ABSTRACT

A monitoring device for movement monitoring for at least one MEMS actuator having at least one detection unit, which is set up to detect at least one movement signal of the MEMS actuator that includes at least one characteristic movement value of the at least one MEMS actuator. It is provided that the monitoring device includes at least one first comparator unit, which is set up to compare the at least one characteristic movement value of the at least one MEMS actuator to at least one reference value.

### CROSS REFERENCE

The present application claims the benefit under 35 U.S.C. § 119 of German Patent Application No. DE 102017220822.8 filed on Nov. 22, 2017, which is expressly incorporated herein by reference in its entirety.

### BACKGROUND INFORMATION

A monitoring device for movement monitoring for at least one MEMS actuator is available in the related art; it has at least one detection unit, which is set up to detect at least one movement signal of the MEMS actuator that includes at least one characteristic movement value of the at least one MEMS actuator.

### SUMMARY

The present invention is based on a monitoring device, in particular for a laser-projection device, for monitoring the movement of at least one MEMS actuator having at least one detection unit, which is set up to detect at least one movement signal of the MEMS actuator that includes at least one characteristic movement value of the at least one MEMS actuator.

It is provided that the monitoring device includes at least one first comparator unit, which is set up to compare the at least one characteristic movement value of the at least one MEMS actuator to at least one reference value.

The monitoring device is preferably intended for use in a laser-projection device. Alternatively or additionally, further application fields of the monitoring device are possible. In particular, the monitoring device may be used in measuring micromirror applications and/or devices, e.g., LIDAR (light detection and ranging), 3D scanning, a particulate sensor, a laser-scanning camera, or other micromirror applications and/or devices that are considered useful by one skilled in the art.

A ‘MEMS actuator’ in particular is to be understood as a mobile microelectromechanical system (MEMS). More specifically, a MEMS actuator is able to use electric energy for a mechanical movement. The MEMS actuator is preferably able to move at least in a linear and at least in an oscillatory manner, in particular in a sinusoidal manner. Additional types of movement of the MEMS actuator are possible, especially types of movement of the MEMS actuator that one skilled in the art considers useful. The MEMS actuator may particularly be developed as a micromirror, a gyroscope or as some other MEMS actuator that seems useful to one skilled in the art.

The detection unit preferably has at least one piezo-measuring bridge and at least one analog-digital converter. Preferably, the piezo-measuring bridge is at least partially made from a piezoresistive material. More specifically, the piezo-measuring bridge is at least partially made from silicon, germanium or some other piezoresistive material that is considered useful by one skilled in the art. When stating that a material is piezoresistive, this is particularly meant to indicate that a deformation of the material as a result of an application of force to the material causes a change in an electric resistance of the material. The change in the electric resistance of the material is preferably detected with the aid of an electric bridge circuit of the piezo-measuring bridge, most preferably using a Wheatstone measuring bridge of the piezo-measuring bridge. The electric bridge circuit of the piezo-measuring bridge preferably supplies an electric voltage signal due to the change in the electric resistance of the piezoresistive material.

An ‘analog-digital converter’ in particular describes an electronic element that is set up to convert analog input signals into digital data signals. More specifically, the analog-digital converter is developed to convert analog electric voltage signals of the piezo-measuring bridge into digital data signals. A digital data signal in particular includes a characteristic movement value of the MEMS actuator. A characteristic movement value preferably represents a characteristic, in particular a constant variable such as an amplitude, of the electric voltage signal. ‘Set up’ particularly is to be understood as specially programmed, configured and/or equipped. The expression that an object is set up for a particular function especially means that the object satisfies and/or carries out this particular function in at least one application and/or operating state.

For the detection of a movement signal of the MEMS actuator, the piezo-measuring bridge is preferably connected to the MEMS actuator, in particular mechanically connected. In response to a force action on the piezo-measuring bridge, the piezo-measuring bridge preferably generates an electric voltage proportionally to the acting force. In particular, different forces are exerted on the piezo-measuring bridge in different positions of the MEMS actuator via the connection of the MEMS actuator to the piezo-measuring bridge. Proportionally to the different forces, the piezo-measuring bridge preferably generates different electric voltages whose time characteristic preferably corresponds to the analog movement signal of the MEMS actuator.

For the transmission of the analog movement signal, the piezo-measuring bridge is connected to the analog-digital converter, preferably in an electrically conductive manner. Preferably, the analog-digital converter converts an analog movement signal of the piezo-measuring bridge into a digital movement signal.

The laser projection device includes a first comparator unit, which is preferably set up to compare the characteristic movement value of the MEMS actuator to at least one reference value. A ‘comparator unit’ in particular is to be understood as a unit that has at least one output unit, at least one processor unit and at least one memory unit as well as a calculation program which is stored in the memory unit. Alternatively, it is possible that the comparator unit is developed as a dedicated digital circuit, in particular as an application-specific integrated circuit (ASIC), which has a memory unit that is developed as at least one register. The output unit, the processor unit and the memory unit are preferably situated on a common chip, on a common circuit board and/or advantageously in a shared housing. The reference value is preferably stored in the memory unit of the first comparator unit. The processor unit of the first comparator unit is advantageously able to carry out a comparison between the characteristic movement value of the MEMS actuator and the reference value using the calculation program. It is alternatively possible that the comparison between the characteristic movement value of the MEMS actuator and the reference value is realizable on the basis of a connection or wiring of the dedicated digital circuit. Depending on a result of the comparison, the output unit may preferably output a corresponding output signal. The output signal may particularly include an item of information to the effect that the movement of the MEMS actuator is taking place without disturbance or it may include the information that the MEMS actuator has encountered a disturbance. It is basically possible that the output signal is conveyed to additional units for further processing. When using the monitoring device in a laser projection device, a safety shutdown of the laser projection device or of individual components of the laser projection device is preferably able to be controlled and/or regulated as a function of the output signal. When the monitoring device is used in a measuring micromirror application and/or in a measuring micromirror device for the detection of at least one measuring variable as a function of the output signal, it is preferably possible to generate a validity signal for the acquired measuring variable. In an output signal that includes the information that the movement of the MEMS actuator is taking place without disturbance, it is particularly possible to generate a validity signal that encompasses an item of information to the effect that the detected measuring variable is valid because of the disturbance-free MEMS actuator. More specifically, given an output signal that includes the information that a disturbance has been encountered in the MEMS actuator, a validity signal is able to be generated that encompasses an item of information to the effect that the detected measuring variable may be invalid due to the disturbance of the MEMS actuator.

The development of the monitoring device according to the present invention advantageously allows for monitoring a movement of the MEMS actuator. In particular, a disturbance of the MEMS actuator is advantageously detectable.

It is furthermore provided that the monitoring device includes a digital signal processor, which in the presence of a sinusoidal movement of the at least one MEMS actuator is set up to ascertain from the at least one movement signal of the at least one MEMS actuator an amplitude and a phase error of the movement of the at least one MEMS actuator, using an algorithm, in particular a CORDIC algorithm (coordinate rotation digital computer algorithm). The amplitude and the phase error of the movement of the MEMS actuator particularly correspond to a characteristic movement value of the MEMS actuator in each case. A ‘digital signal processor’ is to be understood especially as a unit that has at least one input unit, at least one temperature compensation unit, at least one output unit, at least one processor unit and at least one memory unit as well as a calculation program stored in the memory unit. The digital signal processor particularly is set up to process digital signals.

The movement signal of the MEMS actuator is conveyed to the digital signal processor, preferably via the input unit of the digital signal processor, and especially conveyed automatically. The temperature compensation unit of the digital signal processor is particularly set up to detect an instantaneous temperature and to adapt the movement signal as a function of the instantaneous temperature. The piezo-measuring bridge may particularly have a temperature dependency. The piezo-measuring bridge may supply different signals at different temperatures, in particular despite the same action of force on the piezo-measuring bridge. In order to compensate for the temperature dependency of the piezo-measuring bridge, the temperature compensation unit of the piezo-measuring bridge preferably adapts the movement signal as a function of the instantaneous temperature. The calculation program of the digital signal processor preferably has a CORDIC algorithm. A ‘CORDIC algorithm’ in particular is to be understood as an efficient, iterative algorithm that may be used for implementing a multitude of functions such as trigonometric functions, exponential functions, logarithms as well as multiplications and/or divisions. Alternatively or additionally, it is possible that the calculation program of the digital signal processor has a different algorithm than a CORDIC algorithm, in particular an algorithm that is considered useful by one skilled in the art.

If the MEMS actuator moves in a sinusoidal fashion, then the movement of the MEMS actuator preferably has an amplitude and a phase error. The digital signal processor is able to ascertain the amplitude and the phase error of the movement of the MEMS actuator, preferably based on the movement signal of the MEMS actuator. In particular using the movement signal of the MEMS actuator, the processor unit of the digital signal processor is able to calculate the amplitude and the phase error of the movement of the MEMS actuator, utilizing the CORDIC algorithm that is included in the calculation program of the digital signal processor. For the further processing, the digital signal processor may output the ascertained amplitude and the ascertained phase error of the movement of the MEMS, preferably via the output unit. In the presence of a sinusoidal movement of the MEMS actuator, the amplitude and the phase error of the movement of the MEMS actuator are advantageously able to be ascertained from the movement signal of the MEMS actuator.

In addition, it is provided that in the presence of a sinusoidal movement of the at least one MEMS actuator, the at least one first comparator unit is set up to compare the ascertained amplitude of the movement of the at least one MEMS actuator with an amplitude reference value. In the presence of a sinusoidal movement of the at least one MEMS actuator, the ascertained amplitude of the movement of the at least one MEMS actuator in particular corresponds to a first characteristic movement value of the MEMS actuator, and the amplitude reference value in particular corresponds to a first reference value. The amplitude reference value preferably corresponds to an amplitude minimum value, and a disturbance of the MEMS actuator is encountered in particular at an amplitude that is smaller than the amplitude minimum value. The amplitude reference value is preferably stored in the memory unit of the first comparator unit. If the ascertained amplitude is greater than or equal to the amplitude reference value, then the first comparator unit preferably outputs an output signal which includes the information that the movement of the MEMS actuator is free of disturbances. If the ascertained amplitude is lower than the amplitude reference value, then the first comparator unit preferably outputs an output signal including the information that a disturbance of the MEMS actuator has been encountered. In the presence of a sinusoidal movement of the MEMS actuator, a disturbance of the MEMS actuator is advantageously ascertainable on the basis of the amplitude of the movement of the MEMS actuator.

It is furthermore provided that the laser projection device includes at least one second comparator unit, which in the presence of a sinusoidal movement of the at least one MEMS actuator is set up to compare the detected phase error of the movement of the at least one MEMS actuator to a phase-error reference value. The second comparator unit preferably has a similar design as the first comparator unit. In the presence of a sinusoidal movement of the at least one MEMS actuator, the ascertained phase error corresponds to the movement of the at least one MEMS actuator, in particular to a second characteristic movement value of the MEMS actuator, and the phase-error reference value in particular corresponds to a second reference value. The phase-error reference value preferably corresponds to a maximum phase-error value, and a disturbance of the MEMS actuator is particularly present when a phase error occurs that is greater than the maximum phase-error value. The phase-error reference value is preferably stored in a memory unit of the second comparator unit. If the ascertained phase error is smaller than or equal to the phase-error reference value, then the second comparator unit preferably outputs an output signal that includes the information that no disturbance is present in the movement of the MEMS actuator. If the ascertained phase error is greater than the phase-error reference value, the second comparator unit preferably outputs an output signal with the information that a disturbance of the MEMS actuator has been encountered. If a sinusoidal movement of the MEMS actuator is present, a disturbance of the MEMS actuator may be ascertained in an advantageous manner, additionally to and especially simultaneously with an ascertainment based on the amplitude of the MEMS actuator, on the basis of the phase error of the movement of the MEMS actuator.

It is furthermore provided that the laser projection device includes at least one analog-digital converter unit, which is set up to digitize at least one signal of the at least one detection device in the presence of a non-sinusoidal, in particular a sectionally linear, movement of the at least one MEMS actuator, and to detect and store at least one first instantaneous value of the signal of the detection unit and at least one second instantaneous value of the signal of the at least one detection unit, the second value being temporally offset from the first instantaneous value of the signal of the at least one detection unit. An ‘analog-digital converter unit’ in particular describes a unit that has at least one analog-digital converter, at least one memory unit and at least one output unit. The analog-digital converter unit is preferably connected to the piezo-measuring bridge of the detection unit in an electrically conductive manner. It is alternatively possible that the analog-digital converter of the detection unit is used for digitizing the signal, and the analog-digital converter unit is electrically conductively connected to the analog-digital converter of the detection unit. The MEMS actuator is preferably able to execute a triangular and/or saw-tooth-like movement. A triangular and/or saw-tooth-like movement in particular represents a regionally linear movement. The detection and storing of the instantaneous values takes place in particular only during a linear partial movement of the MEMS actuator.

The detection and storing of the first and the second instantaneous values is carried out at a time interval, in particular. Preferably, a detection and storage of a multitude of instantaneous values takes place. A detection and storage of a new instantaneous value preferably always takes place at an identical time interval with respect to an instantaneous value detected and stored immediately prior to the new instantaneous value. In the case of a laser projection device, in particular, a horizontal mirror projects lines onto a projection surface with the aid of a laser beam. If the MEMS actuator is developed as part of a laser projection device, then the detection and storing of the first and the second instantaneous values preferably takes place at an interval of 1 to 1000 lines, and most preferably, at an interval of 70 to 100 lines. The analog-digital digital converter unit is able to store the first and the second instantaneous values preferably in the memory unit of the analog-digital converter unit. In particular, the first instantaneous value is stored in a first memory element, especially in a first register, of the memory element. The second instantaneous value is particularly stored in a second memory element, especially in a second register, of the memory unit. When detecting a further instantaneous value, the second instantaneous value may preferably be transmitted from the second memory element to the first memory element and the further instantaneous value may be stored in the second memory element. Alternatively, it is possible that the further instantaneous value is stored in the first memory element. The first and the second instantaneous values are preferably output with the aid of the output unit of the analog-digital converter unit, in particular to the first comparator unit. It is advantageously possible to detect and store two temporally offset instantaneous values.

Moreover, it is provided that in the presence of a non-sinusoidal, in particular a sectionally linear, movement of the at least one MEMS actuator, the at least one first comparator unit is set up to compare the at least one second instantaneous value of the at least one analog-digital converter unit to the at least one first instantaneous value of the at least one analog-digital converter unit. It is alternatively possible that in the presence of a non-sinusoidal, in particular a sectionally linear, movement of the at least one MEMS actuator, the second comparator unit is set up to compare the at least one second instantaneous value of the at least one analog-digital converter unit to the at least one first instantaneous value of the at least one analog-digital converter unit. In particular, the first instantaneous value corresponds to the reference value, and the second instantaneous value corresponds to the characteristic movement value. The first comparator unit is preferably set up to generate a difference between the first and the second instantaneous values. In particular, the processor unit of the first comparator unit is able to calculate the difference between the first and the second instantaneous values, using the calculation program of the first comparator unit. A comparison may advantageously be carried out between two temporally offset instantaneous values.

In addition, it is provided that in the presence of a non-sinusoidal, in particular a sectionally linear, movement of the at least one MEMS actuator, the at least one first comparator unit is set up to check whether a specified minimum difference exists between the at least one first instantaneous value of the at least one analog-digital converter unit and the at least one second instantaneous value of the at least one analog-digital converter unit. It is alternatively possible that in the presence of a non-sinusoidal, in particular a sectionally linear, movement of the at least one MEMS actuator, the second comparator unit is set up to check whether a specified minimum difference exists between the at least one first instantaneous value of the at least one analog-digital converter unit and the at least one second instantaneous value of the at least one analog-digital converter unit. Alternatively, it is furthermore possible that the monitoring device has a third comparator unit, in particular one that is developed similarly to the first comparator unit, which in the presence of a non-sinusoidal, in particular a sectionally linear, movement of the at least one MEMS actuator, is set up to check, in particular independently of the first and/or the second comparator unit, whether a specified minimum difference exists between the at least one first instantaneous value of the at least one analog-digital converter unit and the at least one second instantaneous value of the at least one analog-digital converter unit. Especially when the first and the second instantaneous values differ by at least the specified minimum value, the movement of the MEMS actuator takes place without disturbance. The specified minimum difference is preferably stored in the memory unit of the first comparator unit. The first comparator unit is preferably set up to compare the difference of the first and the second instantaneous values to the specified minimum difference. The difference of the first and the second instantaneous values in particular corresponds to the characteristic movement value of the MEMS actuator and the specified minimum difference corresponds to the reference value. If the difference of the first and the second instantaneous values is greater than or equal to the specified minimum difference, then the first comparator unit preferably outputs an output signal including the information that the movement of the MEMS actuator is taking place without disturbance. If the difference of the first and the second instantaneous values is smaller than the specified minimum difference, then the first comparator unit preferably outputs an output signal including the information that a disturbance of the MEMS actuator is present. In the presence of a non-sinusoidal, in particular a sectionally linear, movement of the MEMS actuator, it is advantageously possible to detect a disturbance of a MEMS actuator on the basis of two temporally offset instantaneous values.

In addition, the present invention is based on a method for movement monitoring for at least one MEMS actuator with the aid of a monitoring device according to the present invention, the monitoring device including at least one detection unit, which is set up to detect at least one characteristic movement value of the at least one MEMS actuator.

It is provided that the at least one characteristic movement value of the at least one MEMS actuator is compared to at least one reference value, especially in at least one method step. A movement of a MEMS actuator is advantageously able to be monitored. More specifically, it is advantageously possible to detect a disturbance of the MEMS actuator.

Moreover, the present invention is based on a laser projection device having at least one MEMS actuator and at least one monitoring device according to the present invention, the monitoring device having at least one detection unit, which is set up to detect at least one movement signal of the MEMS actuator that includes at least one characteristic movement value of the at least one MEMS actuator.

It is provided that the at least one MEMS actuator is at least partially developed as a mirror element. A ‘mirror element’ in particular is to be understood as an element that reflects electromagnetic radiation, in particular electromagnetic radiation that is visible to the human eye. More specifically, the mirror element is reflective in a range of an electromagnetic spectrum in which the laser projection device emits electromagnetic radiation. The mirror element is preferably at least partially made from a material that reflects electromagnetic radiation. In particular, the mirror element may be made at least partially from gold, silver or silicon or from some other material that reflects electromagnetic radiation and seems useful to one skilled in the art. Alternatively or additionally, it is possible that the mirror element has a coating on a surface of the mirror element that reflects electromagnetic radiation. The coating may preferably be a material that is at least partially made from gold, silver, silicon or from some other material that reflects electromagnetic radiation and is considered useful by one skilled in the art. For a particularly high degree of reflectivity, the mirror element may preferably also have a polished surface, especially a highly polished surface. The mirror element is preferably developed as a horizontal mirror or as a vertical mirror. The laser projection device preferably includes still further components necessary for an operation of the laser projection device. More specifically, the laser projection device may include at least one radiation source for generating a laser beam as well as further components that seem useful to one skilled in the art. If the MEMS actuator is used as a mirror element in a laser projection device, the MEMS actuator is particularly set up to deflect the laser beam, which is potentially dangerous to the human eye. A disturbance of the MEMS actuator is detectable, especially with the aid of the monitoring device, and the laser projection device may be deactivated on the basis of the output signal of the monitoring device. In an advantageous manner, it is possible to ensure that a user and/or an observer will not sustain any physical harm.

In addition, the present invention is based on a laser projector having at least one laser projection device according to the present invention. The laser projector preferably includes still further components required for an operation of the laser projector. In particular, the laser projector may include at least one energy supply, at least one data input, at least one image processor, at least one housing, and also further components that appear useful to one skilled in the art. The laser projector may preferably have a deactivation device, which is provided to shut down the radiation source, the MEMS actuator and/or further components of the laser projector considered useful by one skilled in the art when a disturbance of the MEMS actuator is detected with the aid of the monitoring device. A user-safer laser projector is advantageously able to be provided.

The monitoring device according to the present invention, the method according to the present invention, the laser projection device according to the present invention, and/or the laser projector according to the present invention is/are not meant to be restricted to the use and specific embodiment described above. In particular, to satisfy a method of functioning described herein, the monitoring device according to the present invention, the method according to the present invention, the laser projection device according to the present invention, and/or the laser projector according to the present invention may have a number of individual elements, components and units as well as method steps that deviate from the numbers described herein. In addition, aside from the value ranges indicated in this disclosure, values that lie within the mentioned limits are likewise considered to be disclosed and be usable as desired.

### BRIEF DESCRIPTION OF THE DRAWINGS

Additional advantages result from the description of the figures. The figures illustrate an exemplary embodiment of the present invention. The figures and the description herein include numerous features in combination. One skilled in the art will expediently view the features also individually and combine them into useful further combinations.

FIG. 1 shows a monitoring device according to the present invention, in a block diagram.

FIG. 2 shows a laser projection device according to the present invention, in a schematic illustration,

FIG. 3 shows a laser projector according to the present invention, in a perspective view.

### DETAILED DESCRIPTION OF EXAMPLE EMBODIMENTS

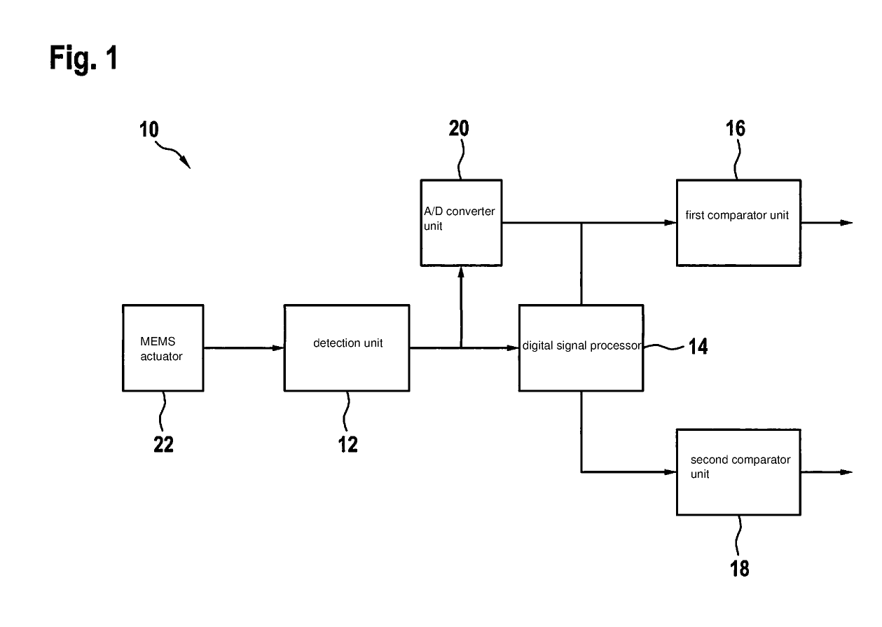

FIG. 1 shows a monitoring device 10 according to the present invention in the form of a block diagram. Monitoring device 10 includes a detection unit 12, a digital signal processor 14, a first comparator unit 16, a second comparator unit 18, and an analog-digital converter unit 20. Also shown is a MEMS actuator 22.

Detection unit 12 is set up to detect at least one movement signal of MEMS actuator 22, which includes at least one characteristic movement value of MEMS actuator 22. MEMS actuator 22 is developed as a mirror element of a laser projection device 24. For a detection of the movement signal of MEMS actuator 22, detection unit 12 has a piezo-measuring bridge, which is not shown further and which is mechanically connected to MEMS actuator 22. The piezo-measuring bridge is developed as a Wheatstone measuring bridge and includes at least one piezo-resistive element. Via a mechanical connection, MEMS actuator 22 exerts a force on the piezo-measuring bridge, which results in an electric voltage signal of the piezo-measuring bridge. Detection unit 12 has an analog-digital converter, which is not shown further and which is set up to convert the analog electric voltage signal of the piezo-measuring bridge into a digital movement signal of MEMS actuator 22.

In the presence of a sinusoidal movement of MEMS actuator 22, the movement signal of MEMS actuator 22 is output to digital signal processor 14. Digital signal processor 14 has a temperature-compensation unit, which is not shown further and is set up to compensate for a possible error of the movement signal of MEMS actuator 22 caused by temperature drift of the piezo-measuring bridge. In the presence of a sinusoidal movement of MEMS actuator 22, digital signal processor 14 is set up to ascertain from the temperature-compensated movement signal of MEMS actuator 22 an amplitude and a phase error of the movement of MEMS actuator 22 with the aid of an algorithm. In the presence of a sinusoidal movement of MEMS actuator 22, digital signal processor 14 is set up to ascertain from the temperature-compensated movement signal of MEMS actuator 22 an amplitude and a phase error of the movement of MEMS actuator 22, using a CORDIC algorithm. The CORDIC algorithm is included in a calculation program, which is stored in a memory unit (not shown further) of digital signal processor 14. A processor unit (not shown further) of digital signal processor 14 is able to calculate the amplitude and the phase error of the movement of MEMS actuator 22 with the aid of the calculation program. The amplitude of the movement of MEMS actuator 22 is output to first comparator unit 16. The phase error of the movement of MEMS actuator 22 is output to second comparator unit 18.

In the presence of a sinusoidal movement of MEMS actuator 22, first comparator unit 16 is set up to compare the amplitude of the movement of MEMS actuator 22, ascertained by digital signal processor 14, to an amplitude reference value. First comparator unit 16 is developed as a dedicated digital circuit. The amplitude reference value is stored in a memory unit (not shown further) of first comparator unit 16, the memory unit being realized as a plurality of registers. If a comparison of the ascertained amplitude of the movement of MEMS actuator 22 with the amplitude reference value shows that the ascertained amplitude is greater than or equal to the amplitude reference value, then first comparator unit 16 outputs an output signal with the information that the movement of MEMS actuator 22 does not exhibit any disturbance. If the comparison shows that the ascertained amplitude is smaller than the amplitude reference value, then first comparator unit 16 outputs an output signal with the information that a disturbance is present in the movement of MEMS actuator 22.

In the presence of a sinusoidal movement of MEMS actuator 22, second comparator unit 18 is set up to compare the phase error of the movement of MEMS actuator 22, ascertained by digital signal processor 14, to a phase-error reference value. Second comparator unit 18 is developed as a dedicated digital circuit. The phase-error reference value is stored in a memory unit, realized as a plurality of registers, of second comparator unit 18. If a comparison of the ascertained phase error of the movement of MEMS actuator 22 with the phase-error reference value shows that the ascertained phase error is smaller than or equal to the phase-error reference value, then first comparator unit 18 outputs an output signal including the information that the movement of MEMS actuator 22 is free of disturbances. If the comparison shows that the ascertained phase error is greater than the phase-error reference value, then first comparator unit 18 outputs an output signal with the information that a disturbance has occurred in the movement of MEMS actuator 22.

Analog-digital converter unit 20 is set up to digitize a signal of detection unit 12 in the presence of a non-sinusoidal, in particular a sectionally linear, movement of MEMS actuator 22 and to detect and store a first instantaneous value of the signal of detection unit 12 and a second instantaneous value of the signal of detection unit 12 that is temporally offset from the first instantaneous value of the signal of detection unit 12. The first and the second instantaneous values are stored in a memory unit of analog-digital converter unit 20, which is not shown further. The first instantaneous value is stored in a first memory element of the memory unit, and the second instantaneous value is stored in a second memory element of the memory unit. Alternatively, it is possible that the signal is digitized with the aid of the analog-digital converter of detection unit 12 and the two instantaneous values are stored in the memory unit of analog-digital converter unit 20. The detection of the first and the second instantaneous values takes place at an interval of 70 to 100 lines. The first and the second instantaneous values are output to first comparator unit 16. Alternatively, it is possible that the first and the second instantaneous values are output to second comparator unit 18 or a third comparator unit that is developed independently of first comparator unit 16 and second comparator unit 18.

In the presence of a non-sinusoidal, in particular a sectionally linear, movement of MEMS actuator 22, first comparator unit 16 is set up to compare the second instantaneous value of analog-digital converter unit 20 to the first instantaneous value of analog-digital converter unit 20. First comparator unit 16 is set up to form a difference between the second and the first instantaneous values. Alternatively, it is possible that second comparator unit 18 or the third comparator unit, which is developed independently of first comparator unit 16 and second comparator unit 18, is set up to compare the first and the second instantaneous values by forming the difference between the second and the first instantaneous values.

In the presence of a non-sinusoidal, in particular a sectionally linear, movement of MEMS actuator 22, first comparator unit 16 is set up to check whether a specified minimum difference exists between the first instantaneous value of analog-digital converter unit 20 and the second instantaneous value of analog-digital converter unit 20. Alternatively, it is possible that in the presence of a linear movement of MEMS actuator 22, second comparator unit 18 or the third comparator unit, which is developed independently of first comparator unit 16 and second comparator unit 18, is set up to check whether a specified minimum difference exists between the first instantaneous value of analog-digital converter unit 20 and the second instantaneous value of analog-digital converter unit 20. The specified minimum difference is stored in the memory unit of first comparator unit 16. First comparator unit 16 is set up to compare the difference between the second instantaneous value and the first instantaneous value to the specified minimum difference. If the difference is greater than or equal to the specified minimum difference, then first comparator unit 16 outputs an output signal that includes the information that the movement of MEMS actuator 22 is taking place without disturbance. If the difference is smaller than the specified minimum difference, then first comparator unit 16 outputs an output signal that includes the information that a disturbance of MEMS actuator 22 is present.

In the following text, a method for movement monitoring for MEMS actuator 22 with the aid of monitoring device 10 is described. In at least one method step, the at least one characteristic movement value of MEMS actuator 22 is compared to at least one reference value. With regard to further method steps of the present method for movement monitoring for MEMS actuator 22 with the aid of monitoring device 10, reference may be made to the preceding description of monitoring device 10 because this description is to be interpreted similarly also for the present method, which therefore means that all features with regard to monitoring device 10 are also considered disclosed with regard to the present method for movement monitoring for MEMS actuator 22 with the aid of monitoring device 10.

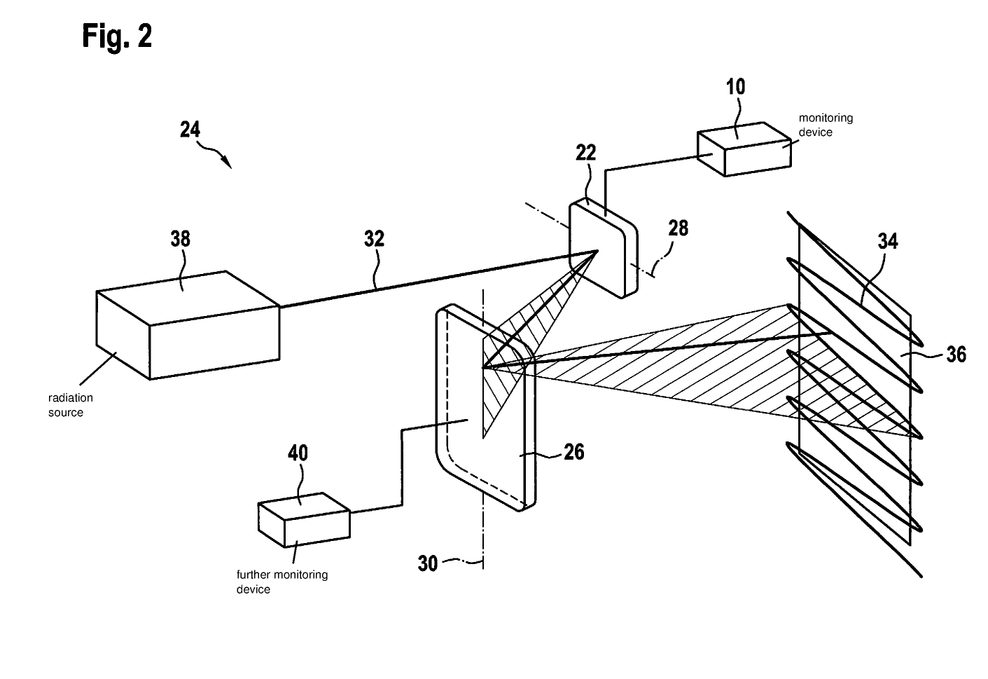

FIG. 2 shows a schematic representation of a laser projection device 24 according to the present invention. Laser projection device 24 includes MEMS actuator 22, which is developed as a mirror element, and a further MEMS actuator 26, which is developed as a mirror element. MEMS actuator 22 is developed as a vertical mirror and is mounted so as to be rotatable about a first axis of rotation 28. Second MEMS actuator 26 is developed as a horizontal mirror and is mounted so as to be rotatable about a second axis of rotation 30. First axis of rotation 28 and second axis of rotation 30 are essentially aligned perpendicular to each other. The term ‘essentially perpendicular’ is particularly meant to define an orientation of first axis of rotation 28 relative to second axis of rotation 30, first axis of rotation 28 and second axis of rotation 30 enclosing an angle of 90°, especially viewed in a plane, and the angle has a maximum deviation in particular of less than 8°, advantageously less than 5°, and most preferably of less than 2°.

MEMS actuator 22 is set up to deflect a laser beam 32 in a vertical direction. Here, a ‘vertical direction’ is meant to describe in particular a direction that is at least essentially perpendicular to first axis of rotation 28. Further MEMS actuator 26 is set up to deflect laser beam 32 deflected by MEMS actuator 22 into a horizontal direction. For a clearer illustration of a method of functioning of further MEMS actuator 26, further MEMS actuator 26 is shown in a partially transparent form. In this context, a horizontal direction is to be understood in particular as a direction that is at least essentially perpendicular to second axis of rotation 30. Using laser beam 32 deflected by the two MEMS actuators 22, 26, laser projection device 24 projects an image 34 onto a projection surface 36. Laser beam 32 is generated by a radiation source 38. Radiation source 38 is developed as a laser diode.

The two MEMS actuators 22, 26 have on their surfaces a coating that is reflective for electromagnetic radiation. The reflective coating is made of gold. Alternatively, the reflective coating may also be made of silver, silicon or some other material that reflects electromagnetic radiation and is considered useful by one skilled in the art. The surfaces of the two MEMS actuators 22, 26 are highly polished for a high degree of reflectivity in each case.

Laser projection device 24 includes monitoring device 10 and a further monitoring device 40. Further monitoring device 40 has a similar development as monitoring device 10. For monitoring the movement of MEMS actuator 22, monitoring device 10 is connected to MEMS actuator 22. For monitoring the movement of further MEMS actuator 26, further monitoring device 40 is connected to further MEMS actuator 26.

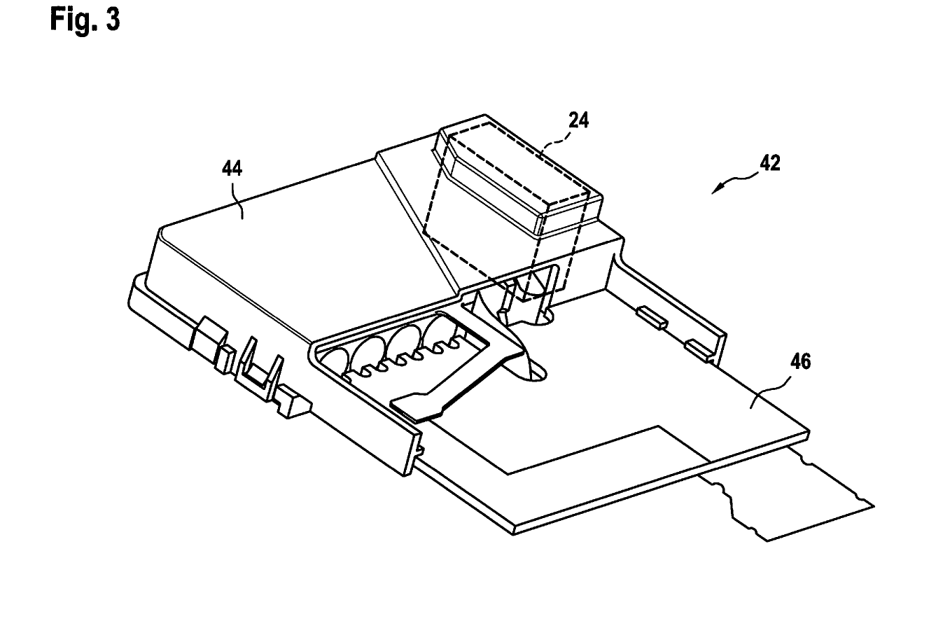

FIG. 3 shows a perspective view of a laser projector 42 according to the present invention. Laser projector 42 includes laser projection device 24. Laser projection device 24 is situated inside a housing 44 of laser projector 42 and sketched in a region surrounded by a dashed line. Laser projection device 24 is situated on a main circuit board 46 of laser projector 42.

What is claimed is:

1. A monitoring device for movement monitoring for at least one MEMS actuator, comprising:
at least one detection unit which is configured to detect at least one movement signal of the MEMS actuator that includes at least one characteristic movement value of the at least one MEMS actuator; and
at least one first comparator unit which is configured to compare the at least one characteristic movement value of the at least one MEMS actuator to at least one reference value.

2. The monitoring device as recited in claim 1, further comprising:
a digital signal processor is configured to, in the presence of a sinusoidal movement of the at least one MEMS actuator, ascertain from the at least one movement signal of the at least one MEMS actuator an amplitude and a phase error of the movement of the at least one MEMS actuator, using a CORDIC algorithm.

3. The monitoring device as recited in claim 2, wherein in the presence of a sinusoidal movement of the at least one MEMS actuator, the at least one first comparator unit is configured to compare the ascertained amplitude of the movement of the at least one MEMS actuator to an amplitude reference value.

4. The monitoring device as recited in claim 1, further comprising:
at least one second comparator unit, which, in the presence of a sinusoidal movement of the at least one MEMS actuator, is configured to compare a detected phase error of the movement of the at least one MEMS actuator to a phase-error reference value.

5. The monitoring device as recited in claim 1, further comprising:
at least one analog-digital converter unit which is configured to digitize at least one signal of the at least one detection unit in the presence of a linear movement of the at least one MEMS actuator, and to detect and store at least one first instantaneous value of the signal of the detection unit and at least one second instantaneous value of the signal of the at least one detection unit, which is temporally offset from the at least one first instantaneous value of the signal of the at least one detection unit.

6. The monitoring device as recited in claim 5, wherein in the presence of a sectionally linear movement of the at least one MEMS actuator, the at least one first comparator unit is configured to compare the at least one second instantaneous value of the at least one analog-digital converter unit to the at least one first instantaneous value of the at least one analog-digital converter unit.

7. The monitoring device as recited in claim 5, wherein in the presence of a sectionally linear movement of the at least one MEMS actuator, the at least one first comparator unit is configured to check whether a specified minimum difference exists between the at least one first instantaneous value of the at least one analog-digital converter unit and the at least one second instantaneous value of the at least one analog-digital converter unit.

8. A method for movement monitoring for at least one MEMS actuator with the aid of a monitoring device, wherein the monitoring device has at least one detection unit, which is configured to detect at least one movement signal of the MEMS actuator that includes at least one characteristic movement value of the at least one MEMS actuator, the method comprising:
comparing the at least one characteristic movement value of the at least one MEMS actuator to at least one reference value.

9. A laser projection device, comprising:
at least one MEMS actuator; and
at least one monitoring device which includes at least one detection unit which is configured to detect at least one movement signal of the MEMS actuator that includes at least one characteristic movement value of the at least one MEMS actuator;
wherein the at least one MEMS actuator is at least partially developed as a mirror element.

10. A laser projector including a laser projection device, the laser projection device comprising:
at least one MEMS actuator; and
at least one monitoring device which includes at least one detection unit which is configured to detect at least one movement signal of the MEMS actuator that includes at least one characteristic movement value of the at least one MEMS actuator;
wherein the at least one MEMS actuator is at least partially developed as a mirror element.
